(19) United States
(12) Patent Application Publication
(10) Pub. No.: US 2001/0025258 A1
(43) Pub. Date: Sep. 27, 2001

(54) Method for product support services

(75) Inventors: Victor T. Foia, Colleyville, TX (US); James W. Watson, Grapevine, TX (US)

Correspondence Address: Paul J. Esatto, Jr., Scully, Scott, Murphy & Presser, 400 Garden City Plaza, Garden City, NY, 11530, US

(73) Assignee: NEC America, Inc., Melvile, NY (US)

(21) Appl. No.: 09/784,858

(22) Filed: Feb. 16, 2001

Related U.S. Application Data
(60) Provisional application No. 60/184,278, filed on Feb. 23, 2000.

(51) Int. Cl. G06F 17/60

(52) U.S. Cl. 705/26

(57) ABSTRACT

The invention is a method and system for providing product support services. The invention allows for access to product support services by non-typical parties and also allows for varying cost structures. A first party is authorized by a product support service provider to receive product support services by request of login identification and passwords. The first party is provided with tokens to purchase and authorized to allocate the tokens to any other party at its discretion. The tokens are accepted by the support service provider in exchange for support services.

### CROSS REFERENCES TO RELATED APPLICATIONS

This patent claims the benefit of U.S. Provisional Application Ser. No. 60/184278, dated Feb. 23, 2000.

### BACKGROUND OF THE INVENTION

This invention generally relates to a method for providing product support services.

The corporate communications environment is undergoing rapid changes brought on by the merging of voice and data technologies, as well as by the participation of the Internet in the delivery of communications content and services. Products designed to service this new environment place novel demands upon the professional charged with their deployment, installation, implementation, and ongoing maintenance. The old product support models cannot fulfill these demands, thus risking to stifle the business growth of manufacturers and distributors alike. There is an increasing need for broader technical expertise on the part of product users.

The present model for receiving product support services typically mandates that only specific users of a product may access the product support environment administered by the product support provider. The product support provider is typically the manufacturer or a qualified support service provider contracted by the manufacturer. The user has typically been the registered purchaser of the manufacturers product. Those permitted to utilize the support services are traditionally limited to users' employees who are certified for the particular products.

Since access to product support has commonly been restricted to certified personnel of the purchaser only, great emphasis is put on a formal, structured relationship between the product support provider and the purchaser. To receive product support after the initial purchase of a product, a purchaser must already have on staff, employees certified by the manufacturer to use this product. If it is a new product for the purchaser, this formality requires the purchaser to either hire employees already certified on the product or train and certify employees before deployment of the product. This is necessary to avoid any lag time between the purchase and deployment of the product and access to product support.

This type of support system has been implemented and utilized throughout the business community to help control and regulate the flow of product support information from the product support provider to the user. It is inherently inefficient and costly for both the purchaser and the service provider.

In today's business community, however, this type of rigid system relying on specific formal relationships is particularly unwieldy. Today, the user might not be the purchaser of a product but might instead be a third party associated with the purchaser. For instance, the purchaser might subcontract work, which requires utilization of the product by a party not trained on the product. This third party may be a strategic partner, a VAR, or a professional service provider. Sometimes, the purchaser may wish a non-employee end-user or a non-certified employee to work on problems directly with the product support provider. These complex business settings require more flexible support mechanisms than what is available. These settings require a support system that allows for the efficient delivery of services to non-traditional parties while maintaining integrity, quality, and security.

### SUMMARY OF THE INVENTION

The invention disclosed herein provides a support environment that accounts for the realities of the current market place. It permits more flexible access to the product support provider, which, in turn, allows for a more enriching and valuable support environment.

The initial step in this method comprises delivering a service account to a receiving party. Only the receiving party receives a service account. The receiving party gains its status as a “receiving party” by well-known methods including written or online application, request or automatically upon some transaction. Typically, after purchasing a product, an application is made to the product manufacturer for a support service account. Upon approval of the application, the support service provider delivers a service account to the receiving party. The service account includes login identification information and passwords. Preferably, the login information and passwords are alphanumeric character strings, secure and proprietary to each receiving party.

Once the receiving party has established a service account, it acquires tokens from the support service provider either through purchase or barter or some other known method. The tokens may be distributed by the receiving party or it's designee to certified employees, non-certified employees or other third parties at its discretion. These tokens are exchanged with the support service provider for the support services. The tokens are not, necessarily, physical embodiments, but may be digital constructs acquired and exchanged electronically.

The receiving party may designate any person it considers qualified to represent it in interfacing with the support environment. This allows access to the support environment by representatives that are not employees and/or certified users. Access is gained by the qualified representative exhibiting login identification to the support service provider and exchanging tokens. Possession of tokens and login identification serves as verification of qualification and authorization.

The tokens are returned to the support service provider by any party that has received them from an authorized purchaser. The support services can be scheduled to cost different values of tokens based on time of day/week/year, duration of service, party qualifications or types of service delivered. For instance, if a party calls for technical support on a Sunday the services can cost differently than if the party had called during business hours. The tokens themselves are typically purchased by an authorized purchaser with money, although, some other compensation can be used. In addition, the cost of tokens can differ based on volume purchasing. These characteristics of cost are controlled and determined by the support service provider or the product manufacturer.

It is preferable that this support environment is administered on a computer network such as the Internet or a private intranet. Application and authorization are received electronically over the network as well as tokens purchased and exchanged. The support services may be provided over the network or by telephone or other known method.

### BRIEF DESCRIPTION OF THE DRAWINGS

FIG. 1 is a diagram of a typical support service environment.

FIG. 2 is a diagram of a first embodiment of the invention.

FIG. 3 is a table according to a first embodiment of the partial cost structure of the invention.

FIG. 4 is a table representing a first embodiment of the partial cost structure of the invention.

FIG. 5 is a table representing a first embodiment of the partial cost structure of the invention.

FIG. 6 is a diagram of a second embodiment of the invention.

FIG. 7 is a diagram of types of services from a support service provider.

FIG. 8 is a diagram of a third embodiment of the invention.

### DETAILED DESCRIPTION OF THE INVENTION

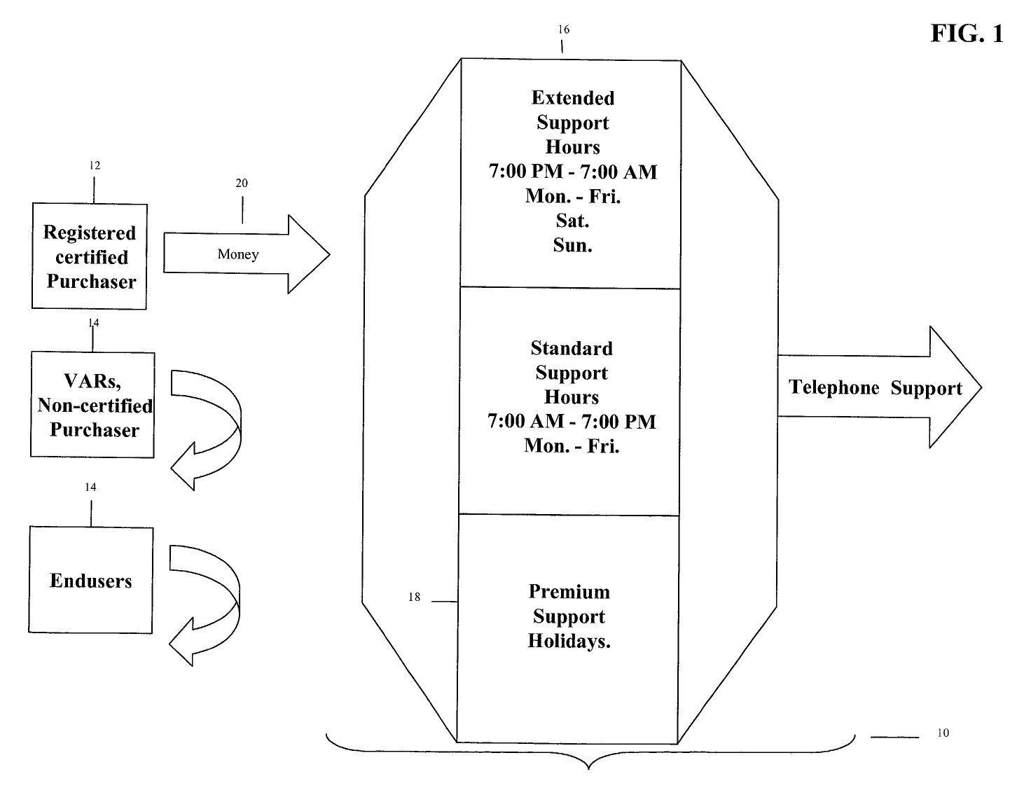

FIG. 1 is a diagram of a typical support service environment 10. Only registered, certified purchasers 12 gain access to the environment. VARS, non-certified purchasers and end users 14 are denied access to the environment 10. The environment 10 has limiting characteristics such as cost 20 based on hour 16 or cost 20 based on day 18. These limiting characteristics determine the cost of services provided. For example, when a certified registered purchaser calls on a Monday at 8:00 AM, she will receive free telephone support service. However, if she calls on a holiday, she will pay premium cost for telephone support service. One will note that this typical environment offers only telephone support.

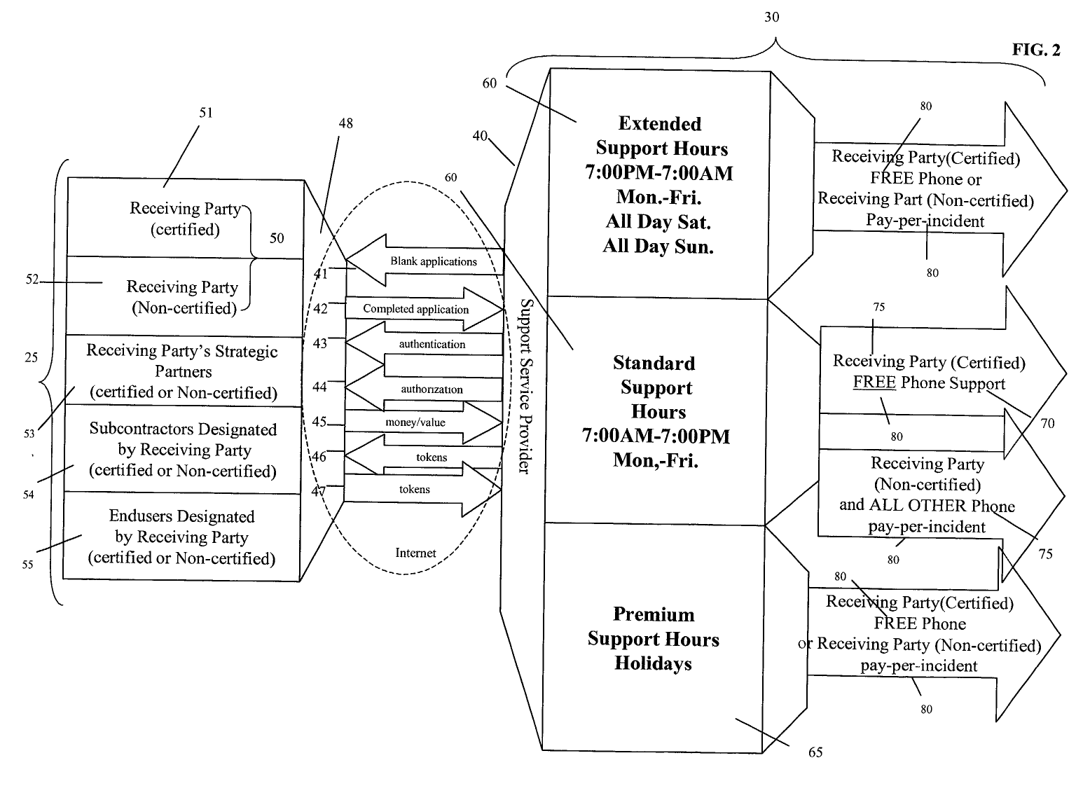

FIG. 2 is a diagram of certain features in a first embodiment of the present invention. Here, access is gained by many different parties 25. These parties 25 are all related by either being the purchaser or having a relationship with the purchaser that authorizes access to the environment 30. The environment 30 is controlled by the manufacturer and/or a support service provider 40. A blank application 41 is initially transferred via the Internet from the support service provider 40 to the receiving party 50. The receiving party, 50, can be certified for a particular product, 51, or non-certified, 52. The application is completed 42 by the receiving party 50 and transferred back to the support service provider 40. Once the completed application 42 is approved by the support service provider 40, authentication information 43, and authorization 44 is transferred back to the receiving party 50 via the Internet. The approval of the application is based on some predetermined criteria which is typical for the marketplace involved. The authentication 43 is a login identification consisting of a unique multi-digit alphanumeric string. Possessing the string indicates one is a receiving party 50 and may open a service account 48 to purchase tokens 45 and 46.

The authorization 44 is information indicating to the receiving party 50 that it may allocate tokens to any party 25. The receiving party 50 may now purchase 45 with money, credit, or other value, via the Internet, tokens from the support service provider 40. The tokens are transferred 46 to the receiving party 50 via the Internet.

The tokens may be distributed by the receiving party 50 to any other party 25 it designates to interact with the support service environment 30. These designees may be the receiving party's strategic partners 53, who may be certified on the product or non-certified. The designee may be a sub-contractor 54 or enduser 55 who, in turn may or may not be certified. The tokens are then transferred back 47, via the Internet, to the support service provider 40. Upon receipt of the tokens, 47, the support service provider provides support services.

The environment 30 consists of limiting factors that characterize it. These limiting factors include time of day 60, date 65, type of service provided 70 and type of party interacting 75. The token cost, 80, is structured on these limiting factors.

In this embodiment, the token cost, 80, is free (requiring no tokens) for telephone service 70 to a certified receiving party, 51, during extended support hours, standard support hours, and holidays. For a non-certified receiving party, 52, it must pay per incident during extended support hours, standard support hours and premium support hours. All other parties also pay-per-incident for each class of environmental limiting factors. While the token cost structure varies by party status and environmental limiting factors, 60, all the varying parties, 25, are given access to the support service environment, 30.

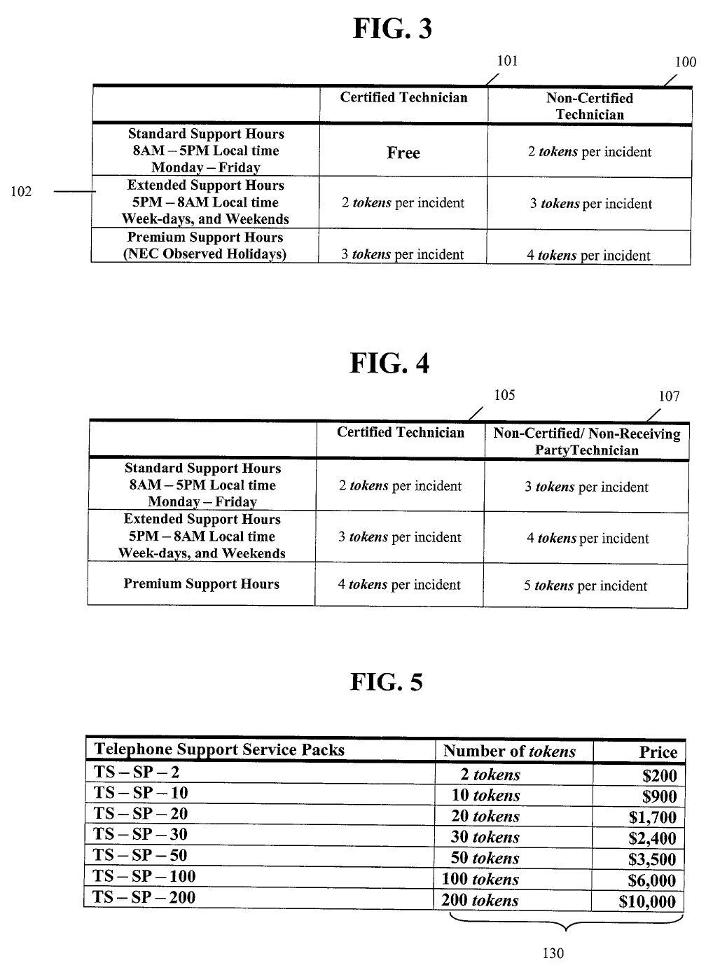

FIG. 3 is a table representing one partial embodiment, different from FIG. 2, of the cost structure of the invention. Here, a non-certified technician 100 pays 3 tokens per incident during extended support hours 102 while a certified technician 101 pays only 2 tokens per incident during the same block of time 102.

FIG. 4 is a table further representing one partial embodiment of the cost structure of the invention. In this table the cost structure for non-receiving parties are represented. A certified, non-receiving party 105 pays differently than a non-certified, non-receiving party 107.

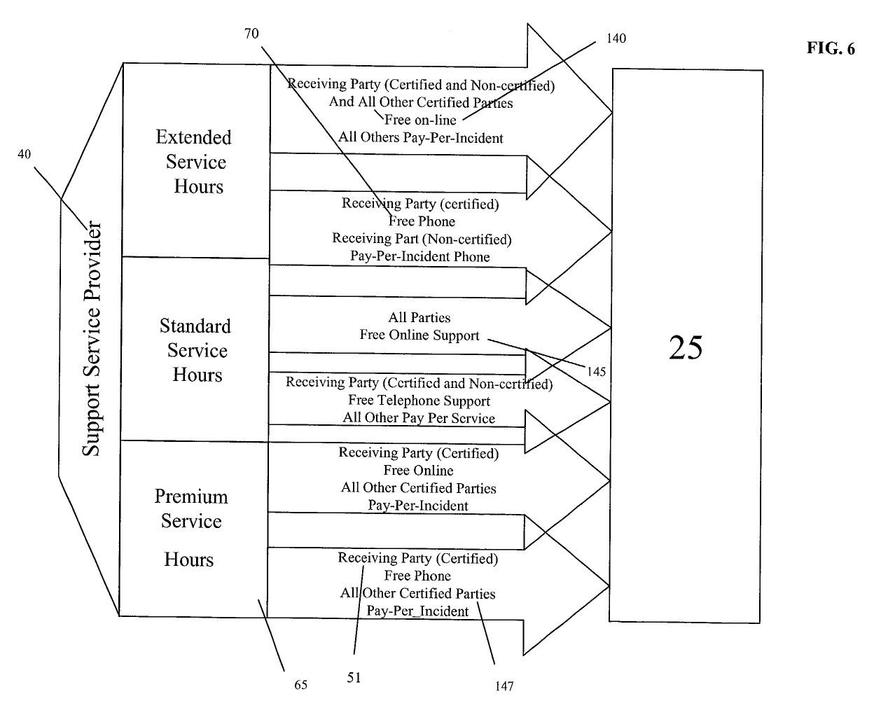

FIG. 5 is a table representing one further portion of the cost structure of the invention. This table represents the cost structure of tokens by volume purchased 130.

FIG. 6 depicts a second embodiment of the support service environment, 30. In this embodiment, on-line support services, 140, are provided by the support service provider, 40, through the Internet as well as telephone based support services, 70. Again, all parties, 25, have access to some level of support services. During standard support hours, all parties receive free on-line support, 145. However, during premium support hours, 65, only a certified receiving party will receive free on-line support. All other parties must pay-per-incident, 147. During extended service hours only a receiving party will receive telephone support. Other parties have no access to telephone support during these hours.

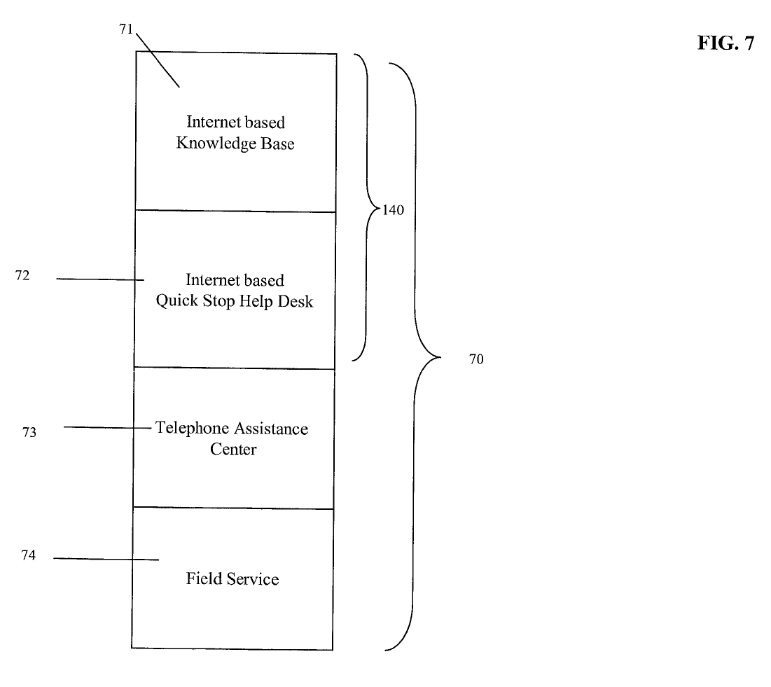

FIG. 7 displays one embodiment of the types of services, 70, offered. Two different on-line services, 140, are offered. The knowledge base, 71, is a collection of solved incidents that had required support services, frequently asked questions, and engineering tips. The quick stop help desk, 72, is a help desk where parties can ask questions and receive answers over the Internet. The telephone assistance center, 73, can be live operators offering assistance or recorded information. Field service, 74, provides trained technicians sent to a location for on-site service.

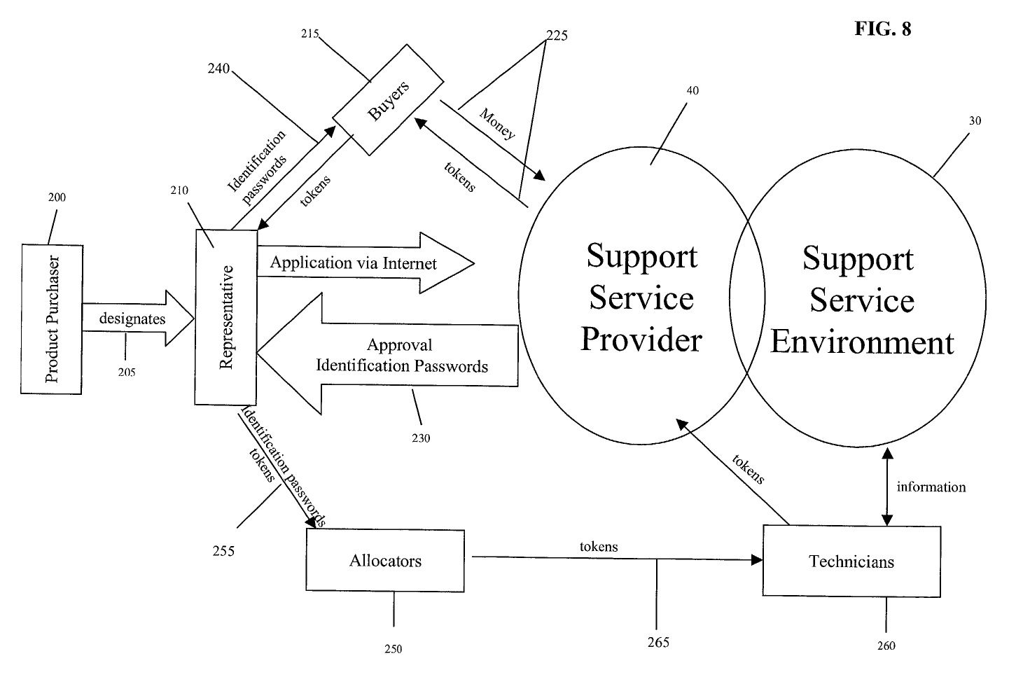

A preferred embodiment of the present invention is depicted in FIG. 8. A purchaser, 200, may apply to open a support service account over the Internet by first designating, 205, a representative, 210. The representative is authorized to open and manage the purchaser's account. This representative may designate other representatives. The representative designates a purchaser's 200 employee or employees as buyers 215. Buyers 215 are empowered to issue purchase orders for tokens online 225. Representatives 2 10 receive, via the Internet, identification and passwords 230 from the support service providers 40. The identification and passwords are passed 240 to the buyers 215 by the representatives 210. The representatives designate other employees of the purchaser as allocators 250 and passes 255 identification, passwords, and tokens to the allocators 250. Allocators 250 designate technicians to interface with the support service environment 30 and pass tokens 265 to the technicians who exchange the tokens with the support service provider 40 for support services.

Token allocation, usage, and account balances may be monitored by the receiving party, the representative and/or the allocators. Monitoring can take place in real time via the telephone or the Internet or other computer network. The representative, buyer, allocator, and technician may be the same person or entity. All online activity can take place on the Internet or any other computer network such as an intranet.

Accordingly, it should be readily appreciated that the method for providing product support services of the present invention has many practical applications. Additionally, although the preferred embodiment has been illustrated and described, it will be obvious to those skilled in the art that various modifications can be made without departing from the spirit and scope of this invention. Such modifications are to be considered as included in the following claims unless the claims expressly recite differently.

What is claimed is:

1. A method of providing product support services comprising:
authorizing a first party to receive service by providing a service account to the party containing login identification information;
providing tokens for the first party to purchase to be used in exchange for support services and authorizing the first party to allocate the tokens to other parties designated at the first party's discretion;
accepting the tokens from the first party's designee, and;
providing support services to the party possessing the tokens in exchange for the tokens.

2. A method of providing support as in claim 1 wherein:
all authorizations are provided over a computer network.

3. A method of providing support as in claim 1 wherein:
the tokens are provided and exchanged electronically over a computer network.

4. A method of providing support as in claim 1 wherein:
the tokens are purchased and their cost differs based on a volume purchased.

5. A method of providing support as in claim 1 wherein:
the exchange of tokens for support services differs in rate based on a characteristic inherent to the party exchanging tokens.

6. A method of providing support as in claim 1 wherein:
the exchange of tokens for support services differs in rate based on the time of day it is exchanged.

7. A method of providing support as in claim 1 wherein:
the exchange of tokens for support services differs in rate based on the date it is exchanged.

8. A method of providing support as in claim 1 wherein:
the exchange of tokens for support services differs in rate based on the type of support services supplied.

9. A method of providing support as in claim 1 wherein:
the exchange of tokens for support services differs in rate based on the duration of the support services supplied.

10. A method of providing support as in claim 1 wherein:
the identification information is a unique multi-digit alphanumeric character string.

11. A method of providing support as in claim 1 wherein:
the types of support services provided are Internet based services, telephonic based services, and field based services.

12. A method of providing support as in claim 1 wherein:
the other parties are not employees of the first party.

13. A method of providing support as in claim 12 wherein:
the other parties are not certified users of the product.

14. A method of providing support as in claim 1 wherein:
the other parties are not certified users of the product.

15. A product support system comprising:
means for authorizing a first party to receive product support services by providing a service account containing login identification information;
means for providing tokens to the first party to be used in exchange for product support;
means for accepting the tokens and login identification from any party possessing them in exchange for the product support services, and;
means for delivering product support services to the party possessing the login information and exchanging tokens.

16. A product support system as in claim 15 wherein:
the means for providing, accepting and exchanging tokens is a computer network.

17. A product support system as in claim 15 wherein:
the party possessing the login information is not an employee of the first party.

18. A product support system as in claim 17 wherein:
the party processing the login identification is not a certified user of the product.

19. A product support system as in claim 15 wherein:
the party possessing the login information is not a certified user of the product.

20. A product support system as in claim 15 wherein:
the means for authorizing the first party to receive product support services is an acceptance of an electronic application on a computer network.

21. A method of providing product support services comprising:
providing an online application for product support services;
processing the application for approval or denial based on predetermined criteria;
instructing an approved first party to designate a representative who is authorized to open and manage a service account for the first party;
instructing the representative to apply online to open the service account;
instructing the representative to designate a buyer for issuing online purchase orders for the purchase of tokens;
providing the representative with unique identification and passwords to supply to the buyer;
instructing the representative to designate an allocator;
authorizing the allocator to designate a technician who may receive the product support service;
instructing the allocator to provide the technician with the identification, tokens and passwords, and;
providing product support services to the technician in exchange for tokens after approval of identification and passwords.

22. A method of providing product support services as in claim 21 wherein:
the product support services are Internet based, telephonic based and field based.

23. A method of providing product support services as in claim 21 wherein:
the service account is electronically managed through the Internet.

24. A method of providing product support services as in claim 21 wherein:
token allocation, token usage, and token balances are monitored in real time by a party selected from the group consisting of the first party, the representative, and the allocator;

25. A method of providing product support services as in claim 21 wherein:
the representative, the buyer, and the allocator are the same entity.

26. A method of providing product support services as in claim 21 wherein:
the technician is not an employee of the first party.

27. A method of providing support services as in claim 26 wherein:
the technician is not a certified user of the product.

28. A method of providing product support services as in claim 21 wherein:
the technician is not a certified user of the product.

29. A method of providing product support services as in claim 21 wherein:
the exchange of tokens for support services differs in rate based on a characteristic inherent to the party exchanging tokens.

30. A method of providing product support services as in claim 21 wherein:
the exchange of tokens for support services differs in rate based on the time of day it is exchanged.

31. A method of providing product support services as in claim 21 wherein:
the exchange of tokens for support services differs in rate based on the date it is exchanged.

32. A method of providing product support services as in claim 22 wherein:
the exchange of tokens for support services differs in rate based on the type of support services supplied.

33. A method of providing product support services as in claim 21 wherein:
the exchange of tokens for support services differs in rate based on the duration of the support services supplied.

34. A product support system comprising:
an application for product support;
means for accepting the application from a first party for approval or denial based on a predetermined criteria, and;
a computer network for: transferring the approval of an application, which contains login identification and passwords composed of an alphanumeric character string, from a support service provider to the first party; providing tokens to be purchased by the approved first party from the support service provider; transferring and receiving tokens to and from the first party and the support service provider, and; receiving tokens from any designee of the first party in exchange for product support services whereby the approved first party is identified by the login identification and purchases tokens which are then distributed to the designee who, in turn, returns the tokens in exchange for product support services from the support service provider.

35. A product support system as in claim 34 wherein:
the application is provided electronically online.

36. A product support system as in claim 34 wherein:
the first party designates a representative who is authorized to open and manage a service account;
the first party transfers the login identification to the representatives;
the representative designates a buyer for issuing online purchase orders for the purchase of tokens from the support service provider;
the representative provides the buyer with the login identification and passwords;
the buyer designates an allocator who designates a technician;
the buyer transfers the tokens, login identification and passwords to the allocator; and,
the allocator transfers the tokens to the technicians who exchanges them for product support.

37. A product support system as in claim 36 wherein: the technician is not an employee of the first party.

38. A product support system as in claim 37 wherein:
the technician is not a certified user of the product.

39. A product support system as in claim 36 wherein:
the technician is not a certified user of the product.

40. A product support system as in claim 34 wherein:
the designee is not an employee of the first party.

41. A product support system as in claim 34 wherein: the designee is not certified for the product.
